(19) United States
(12) Patent Application Publication
(10) Pub. No.: US 2010/0319178 A1
(43) Pub. Date: Dec. 23, 2010

(54) NEEDLE REMOVER

(75) Inventors: Yau Wong, Singapore (SG); Ee Lee Daniel Tan, Singapore (SG)

Correspondence Address: ALSTON & BIRD LLP, BANK OF AMERICA PLAZA, 101 SOUTH TRYON STREET, SUITE 4000, CHARLOTTE, NC, 28280-4000, US

(73) Assignee: NANYANG POLYTECHNIC, Singapore (SG)

(21) Appl. No.: 12/446,517

(22) PCT Filed: Aug. 1, 2007
(86) PCT No.: PCT/SG2007/000228

§ 371 Date: Apr. 21, 2009

(30) Foreign Application Priority Data
Nov. 14, 2006 (SG) 200607832-3

(51) Int. Cl. B23P 19/00

(52) U.S. Cl. 29/426.1; 29/283

(57) ABSTRACT

An apparatus (1) for removing a needle from a syringe comprising a housing (20, 30); a sliding member (10) slidingly engaged within said housing (20,30), said sliding member (10) having a recess (5) for receiving the needle mounted to the syringe; at least two gripping members (40) in communication with the sliding member (10) such that on sliding the sliding member (10) within the housing (20,30), the gripping members (40) progressively converge, wherein the gripping members (40) are positioned such that a point of convergence of the gripping members (40) coincides with a portion on the needle to grip said needle.

### FIELD OF THE INVENTION

The invention relates to syringes used in a medical environment and more particularly the disposal of said needles after use in a hospital, clinic etc. In particular the invention relates to a device and method for safely disposing of associated needles.

### BACKGROUND

The problem of safe disposal of syringes and more particularly needles is well established for the control of accidental transmission of blood borne diseases not to mention injury, hospital personnel as well as responsible for the removal of waste products.

Whilst syringes used for recreational drug use have their own particular problems associated with safe disposal, in a medical environment whereby syringes are frequently used, the associated volume of syringes and needles required for disposal is significant. It would be preferably to dispose of used syringes and needles separately as each pose different types of problems. The syringes without the needles merely need to dispose of unused chemical compounds whereas the needles have the greater problem of needle stick injuries requiring greater caution in their disposal. The disposal of syringes still having the needles attached, however, requires unnecessary volume of refuse as sharps containers fill quickly because injections have to be given on schedule. For safety reasons, the sharps container must be replaced when half full. As there is not enough manpower to replace frequently and promptly, healthcare workers often fill it to the brim to the extent that needles point out dangerously at the opening. Consequently, it would be a more economical solution to be able to divide the two into the more appropriate disposal containers for instance, a sharps container for the needles and a bio hazard bag for the syringes.

Unfortunately, the disengagement process puts the healthcare worker at the greatest risk of getting pricked. Typically, he or she will put the cap back and twist to disengage the needle. The cap, being narrow, is easily missed and the needle will prick the finger holding the cap.

Apart from the inconvenience of having to separate the needle and syringe after every use, it does nevertheless pose a hazard for a needle stick injury for said removal and so without the proper method, such separation is not practical.

Alternative methods include cutting the needle from the syringe using a guillotine or shear type arrangement. However, this does require both hands and therefore greater complexity in merely throwing away the syringe and needle attached not to mention the potential of the needle flying off in an uncontrolled manner.

Alternatively, an electrically driven mechanism may engage the needle and rotate the needle or syringe relative to the other portion, and so remove the needle from the syringe. Given the high volume of syringes within a hospital environment, many of such devices may be required which would be both cumbersome.

Thus, a device that could be used single-handedly by a user, which is relatively inexpensive and also is broadly adaptable to both luer lock type needles as well as slip tip hub type needles, be most advantageous.

A different type of device is that disclosed in U.S. Pat. No. 5,531,323, the contents of which are incorporated herein by reference. Here, a syringe having a needle attached may be inserted within a device having an inclined metal member with a slot attached thereto. Insertion of the syringe to the device, the hub of the needle engages slot of the member, locking the hub in place and so allowing the user to rotate the syringe whilst maintaining the needle fixed in place. Thus the syringe can be separated from the needle one handed and relatively inexpensively. By attaching this device to a sharps container, the needle on separation is free to fall into the container and so preventing a needle stick injury.

Whilst this provides a reasonable solution in principle, in fact, the device has serious drawbacks . . . . For instance the wide range of syringes and needles suggest that the slot will need to be of different sizes to suit different arrangements. If for instance a syringe being larger than the slot device being used, the needle may become wedged in the slot and cannot easily be removed without dismantling the device. Alternatively if the slot is too large, it may not fully engage the hub and so permit rotation of the hub and so prevent removal of the needle from the syringe. It follows therefore that this arrangement is restricted to certain size syringes only and so several of such devices will be required to accommodate all syringe sizes.

Another device is that disclosed in U.S. Pat. No. 6,202,843, the contents of which are incorporated herein by reference. Here a syringe is inserted in a similar device but instead of a slot, screen loaded pin engages the hub or more precisely the flutes that project from the hub preventing rotation of the needle when the syringe is rotated.

The problem associated with this device is that there is no way of controlling the force by which the pin engages the hub of the needle. Thus if the hub is screwed particularly tightly onto the syringe then there is no way of adjusting the application force to ensure the pin does not skip over flutes on rotation of the syringe. Further this device is restricted to needles having flutes on the hub. For those needles not having flutes the force applied by the pin cannot practically be sufficient to provide frictional resistance sufficient to remove the needle from the syringe. Therefore as with the earlier prior art devices this particular device is also restricted to a certain category of needle and not broadly applicable to needles in general.

It is therefore an object of the present invention to provide a device that is more applicable to a wider range of needles than the prior art.

### SUMMARY OF THE INVENTION

In a first aspect the invention provides an apparatus for removing a needle from a syringe comprising a housing; a sliding member slidingly engaged within said housing, said sliding member having a recess for receiving a needle mounted to a syringe; at least two gripping members in communication with the sliding member such that on sliding the sliding member within the housing, the gripping members progressively converge, wherein; the gripping members are positioned such that a point of convergence of the gripping members coincides with a portion on the needle to grip said needle.

In a second aspect the invention provides a method of removing a needle from a syringe comprising the steps of: inserting a needle mounted to a syringe into a recess of sliding member, whilst said sliding member is in a first position, said sliding member slidingly engaged within a housing; biasing said sliding member to slide within said housing; said sliding member biasing at least two gripping members to progressively converge, said gripping members positioned such that a point of convergence of the gripping members coincides with a portion on the needle to grip said needle, and; gripping said needle with said gripping members.

A device that can safely disengage and drop just the needle into the sharp container will make each container last longer and solve 3 problems:
1. Shortage of manpower to replace sharp containers frequently and promptly;
2. Storage space in the wards to keep sufficient number of fresh containers to last until the next supply;
3. Storage space in the ward to keep the half-filled containers before the disposal company removes them.

By providing a more convenient and consequently, more appealing method of separation potential injury may be averted. Thus, the invention allows for single handed use to engage the needle and unscrew if desired, without using a second hand. Importantly, the user determines when the needle is to be gripped, by selectively pushing the sliding member into position. Thus, unlike the prior art, which automatically engages the needle, the user maintains greater control over the process.

Further, by engaging the gripping means as a result of sliding the sliding member, the amount of force applied is again controlled by the user. Thus, if the needle is particularly difficult to remove, the user need only press harder on the sliding member to apply an additional gripping force, and so overcome a more stubborn and resistant needle. Such control does not exist in the prior art.

In a preferred embodiment, the sliding member may be restrained from sliding by resilient members from the first to the second position, such that on release of the sliding member, said sliding member is biased back to the first position. In a more preferred embodiment, these resilient members may be springs arranged parallel to the axis of travel of the sliding member.

It is central to the invention that, once the needle is gripped, the syringe be free to rotate within the device. To meet this requirement, the sliding member may also be prevented from rotation. To assist in the prevention of rotation of the sliding member, the housing, and particularly the surface along which the sliding member slides, may include guides. These guides may be adapted to permit the linear motion of the sliding movement, but prevent rotation. An example includes having ribs formed along the surface of the housing, in contact with the sliding member. These ribs may be directed parallel to the path of the sliding member and have accommodating grooves in the sliding member. Thus, for the sliding member to rotate, the rib would need to “skip out” of the groove. For the housing and sliding member to be made from relatively rigid materials, such as hard plastic, aluminium or steel, this is very unlikely given the relatively low forces involved with removing the needle.

In a preferred embodiment, the sliding member may be substantially cylindrical in shape, fitting within a circular orifice of the housing. Further, the sliding member may have an internal void with inclined surfaces on an inside face of the void. This may have the advantage of bearing against the gripping members, such that as the sliding member slides, the inclined surface over surfaces, may act as a wedge, progressively forcing the gripping members inwards toward the point of convergence. Thus, in this embodiment, the sliding member acts on the gripping members by progressively wedging the gripping members to a point at which they contact and grip the needle.

In a preferred embodiment, the portion of the needle gripped by the gripping members includes the needle hub. Alternatively, the gripping members may grip the needle shaft. Whilst caution may be required in doing so, gripping of the shaft has the advantage of providing a greater length of member in which to grip.

Depending on the type of needle involved, the gripping members may engage or grip the hub of the needle in a number of different ways. For instance, for a hub having flutes projecting from the hub, which may be used to grip when unscrewing a luer lock needle, the gripping members may engage these flutes.

Alternatively, some needles do not have such flutes, and so the gripping means may be adapted to provide a frictional force to the hub in order to engage it. The apparatus according to any one of the preceding claims, wherein the gripping members engage the needle hub through friction.

In a preferred embodiment, there may be a pair of gripping members, or alternatively four gripping members. These may include lever type arrangements, whereby each member is anchored to the housing, with the inclined surfaces of the sliding member contacting an opposed end of the member and sliding down the member, whilst pushing the member towards a point of convergence. Said point of convergence may be at a centre line of the sliding member, in the circumstance of the needle being inserted into a recess of the sliding member which is centrally located.

The gripping members may be formed from a range of materials. It may be advantageous to use a material that increases friction, for a better grip, at the portion that contacts the needle. Such materials may include visco-elastic materials such as silicone, polyurethane etc. Alternatively, a polyolefin may be used such as HDPE or polypropylene.

It may be useful to attach the device to a container, and more so, to a container that contains “sharps” such as discarded needles, scalpels etc. To this end, the housing may be connectable to such a container, either integrally moulded, screwed in place, press fit into place, or perhaps wedged in using an interference fit.

### BRIEF DESCRIPTION OF DRAWINGS

It will be convenient to further describe the present invention with respect to the accompanying drawings that illustrate possible arrangements of the invention. Other arrangements of the invention are possible and consequently the particularity of the accompanying drawings is not to be understood as superseding the generality of the preceding description of the invention.

FIG. 1 is an isometric view of a needle remover according to one embodiment of the present invention;

FIG. 2A is a plan view of the needle remover of FIG. 1;

FIG. 2B is a cross sectional elevation of the needle remover of FIG. 1;

FIG. 3A is a cross sectional elevation of a sliding member for the needle remover of FIG. 1;

FIG. 3B is an isometric view of the sliding member of FIG. 3A;

FIG. 3C is a further isometric view of the sliding member of FIG. 3A;

FIG. 4A is an isometric view of a gripping member for the needle remover of FIG. 1;

FIG. 4B is a further isometric view of the gripping member of FIG. 4A;

FIG. 5A is an isometric view of an upper housing for the needle remover of FIG. 1;

FIG. 5B is a further isometric view of the upper housing of FIG. 5A;

FIG. 6A is an isometric view of a lower housing for the needle remover of FIG. 1;

FIG. 6B is a further isometric view of the lower housing of FIG. 6A;

FIGS. 7A to D are cross sectional elevation views giving sequential process steps according to a further embodiment of the present invention.

### DESCRIPTION OF PREFERRED EMBODIMENT

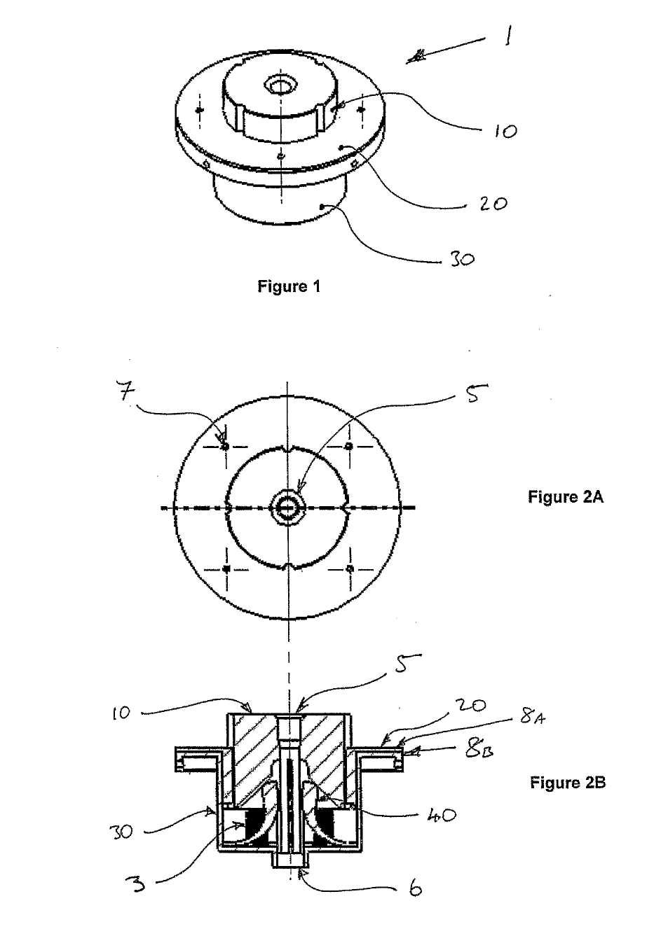

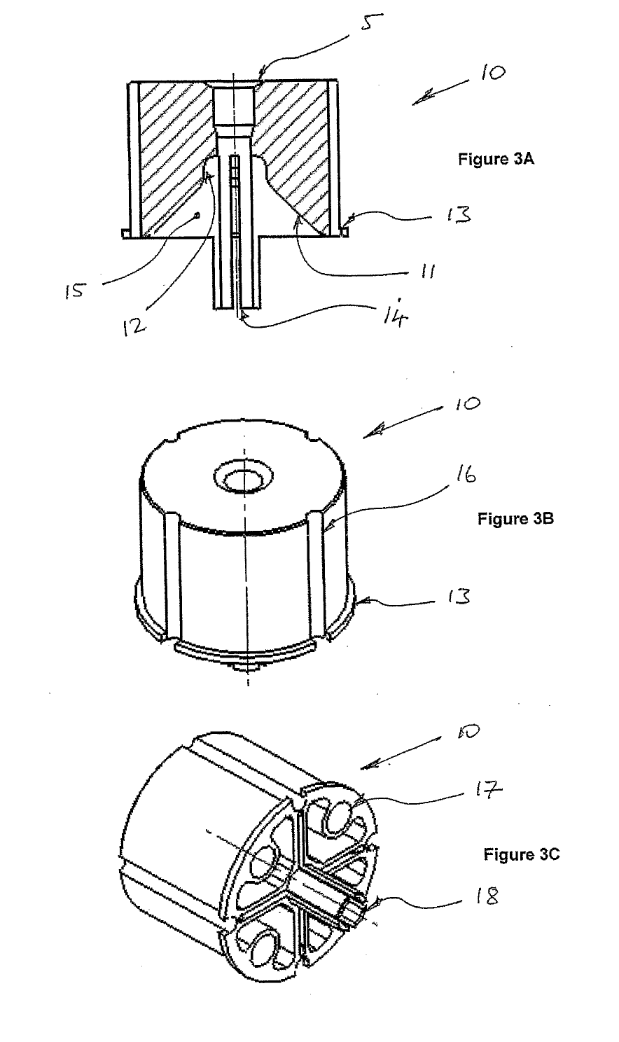

FIGS. 1, 2A and 2B show an assembled needle remover 1 ready to be fitted to the opening of a sharps container or other container for receiving used needles, scalpels etc. It should be noted that this embodiment of the present invention is adapted to mount to the sharps container. In other embodiments the needle remover may be integral with the sharps container or mounted in a different manner, such as a screw thread on the housing 20, 30 or a press fit.

The needle remover 1 comprises an upper housing 20 and a lower housing 30.

The upper housing 20 includes screw or bolt holes 7 and when mounted together the two housing elements have cooperating flange portions 8A, B through which the bolts fit to not only mount the needle remover 1 to the sharps container but to also maintain the connection between the upper and lower housing 20, 30.

In sliding engagement with the housing elements 20, 30 is a sliding member 10. To bias the sliding member there are springs 3 located intermediate a lower portion of the sliding member 10 and the base of the lower housing 30 so as to push the sliding member upwards. The sliding member is held in place by a flange member 13 contacting the upper housing preventing the sliding member from exiting the housing elements 20, 30. Also located within the housing elements 20, 30 is a gripping assembly 40 which has members in sliding contact with the sliding member 10.

The entry orifice 5 in the sliding member 10 receives a syringe having a needle attached thereto. The lower housing 30 further has an exit orifice 6 for permitting a needle to fall into the sharps container following removal from the syringe. Thus, the operation of the needle remover 1 permits the removal of a needle from a syringe without direct contact by the user and so preventing needle stick injuries.

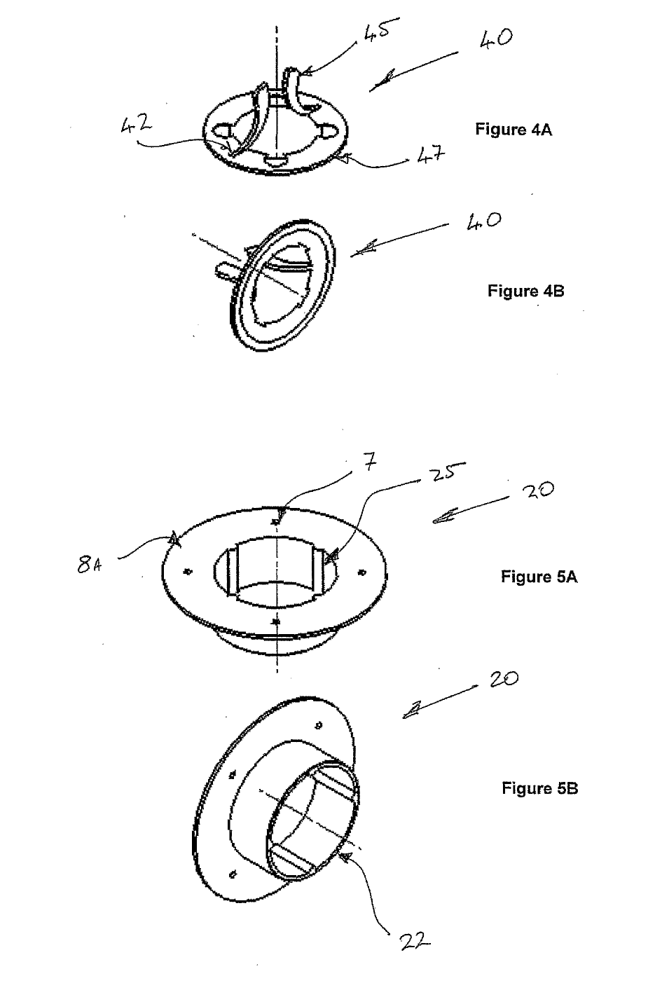

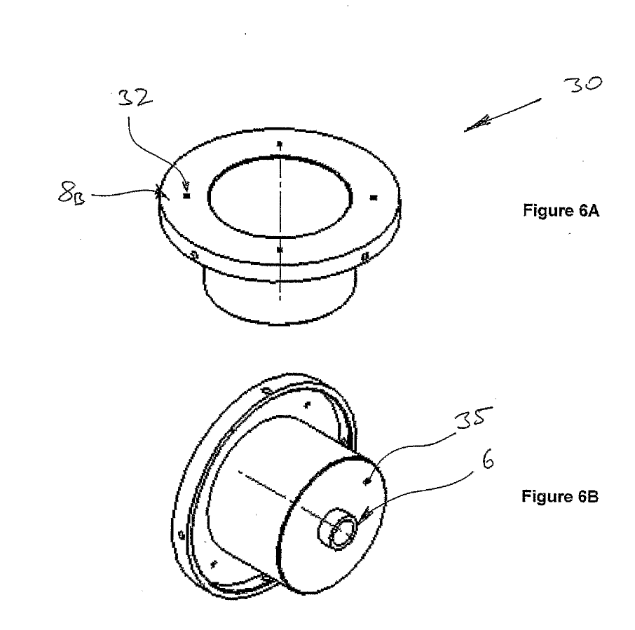

The individual components making up the needle remover 1 will now be described with reference to FIGS. 3 to 6. Sliding member 10 includes the entry orifice 5 through which the syringe having the needle attached is placed. The sliding member 10 is generally cylindrical in shape. To prevent rotation of the sliding member 10 there are included grooves 16 placed around the periphery of the sliding member 10 and directed parallel to the longitudinal axis of the sliding member 10. These grooves 16 correspond to ribs 25 positioned on an internal bore of the upper housing 20 into which the sliding member 10 fits. Accordingly, engagement between the grooves 16 and ribs 25 permits linear movement of the sliding member 10 but prevents rotation.

The sliding member 10 further includes a plurality of recesses 17, 18 in the base. One category of recesses includes holes into which the springs 3 fit, so that they are restrained from buckling during compression. The second category includes slots 15 into which the gripping members fit. The slots 15 act to maintain the gripping members in an upright orientation, preventing lateral movement. Each slot 15 includes an inclined surface 11 against which the gripping members bear. Further, an enlarged area having substantially a vertical surface 12 is located adjacent to the apex of each slot 15. The inclined surface 11 is arranged to contact the gripping members 45 and on sliding movement of the sliding member 10 progressively converge the gripping members 45 to a point at which they grip the hub of a needle inserted inside the sliding member. The gripping members 45 are shaped to fit within the enlarged area. The vertical surface 12 of the sliding member 10 is shaped such that movement of the sliding member no longer progressively converges with the gripping member 45, but maintains a relative position for the last portion of the full reciprocating stroke of the sliding member 10. The sliding member further includes a channel 14 which fits within an exit portion 18 which further fits within the exit orifice 6 of the lower housing.

The gripping members 45 are mounted within an assembly 40 comprising a ring 47 for fitting within the lower housing 30. The gripping members 45 are pivotably connected at pivot point 42 to the ring such that when the gripping members are biased to the convergent point it is achieved through rotation about the pivot 42. The gripping assembly 40 may be an integrally moulded member made from a material suitable for gripping such as polypropylene, HDPE or other relatively soft but resilient polymer. Other such materials are possible and will be envisaged by the skilled worker. Alternatively the ring may be metallic with polymer gripping members 45 connected through some mechanical engagement at the pivot point 42.

The upper housing 20 which may also be referred to as a CAP fits to the lower housing 30 in this embodiment, fitting within the lower housing 30 in a sleeve-like manner. The upper housing includes a flange 8A which corresponds to the flange 8B of the lower housing 30. Further located within the flange 8A of the upper housing 20 are bolt holes 7 through which the needle remover 1 may be bolted or screwed into the sharps container. Within a bore of the upper housing 20 are located ribs 25 to correspond to the grooves 16 of the sliding member 10. Further, there is located a lower portion 22 of the upper housing 20 against which the flange 13 of the sliding member 10 contacts when the sliding member 10 is biased upwards by the springs 3.

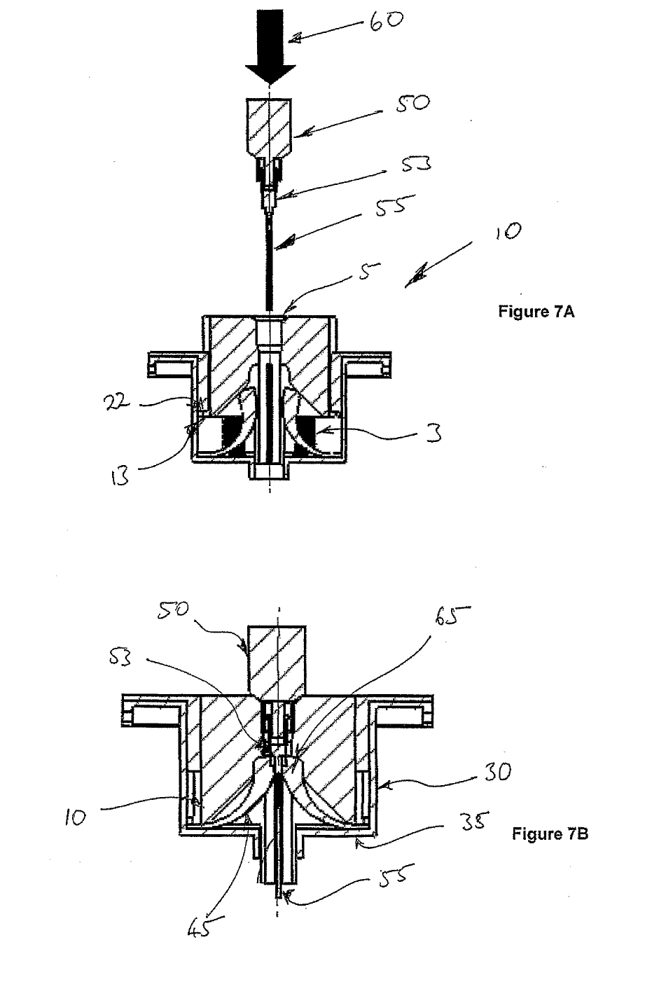

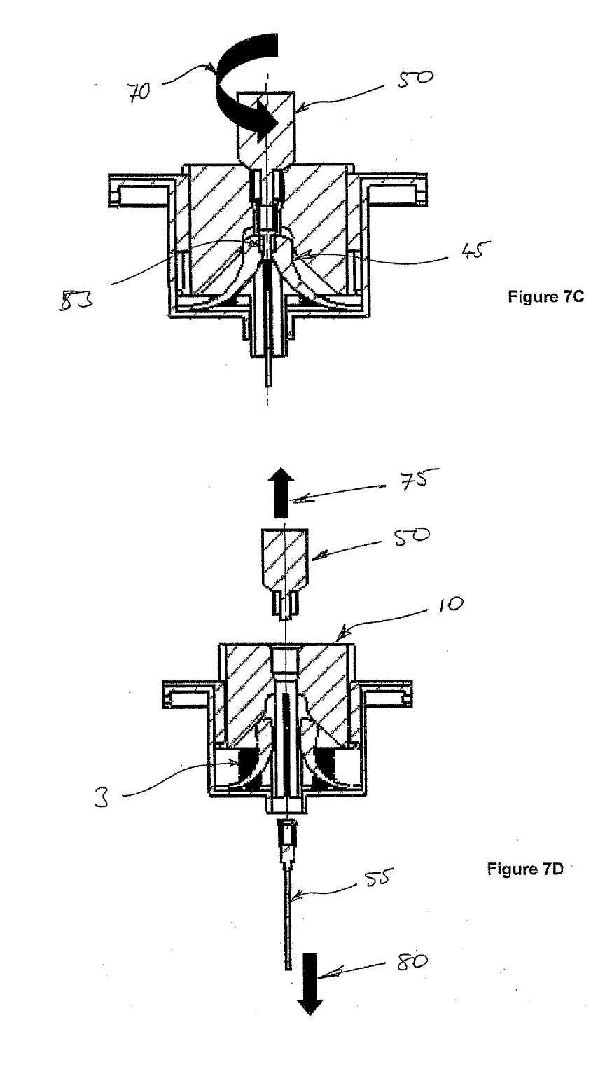

FIGS. 7A to D show the sequential steps in removing a needle 55 from a syringe 50. The first step involves inserting 60 the syringe 50 into the entry orifice 5 of the sliding member 10. In this initial position the sliding member 10 projects upwards from the housing elements 20, 30 through biasing from the springs 3. In this case, the flange 13 of the sliding member is in contact with the lower portion 22 of the upper housing 20.

As the syringe is inserted, the sliding member 10 is pushed downwards against the resistance of the springs 3 causing the gripping members 45 to contact the sliding member 10 along the inclined surface 11. The inclined surface 11 bias the gripping members 45 to converge inwards towards the hub 53 of the syringe. The internal surfaces of the sliding member 10 are arranged such that at a point at which the gripping members converge coincides with the hub 53 of the needle 55 and so gripping said hub. Further the gripping members then fit within the enlarged portion of the slots 15 within the sliding member 10 such that the gripping members 45 no longer converge but maintain a position gripping the hub 53.

In this position the needle is fixed, preventing rotation whilst pressure is maintained on the sliding member 10. In this position the syringe 50 may be rotated 70 relative to the needle and thus work free from the needle 55. It should be noted that whether the needle 55 is mounted to the syringe 50 via a luer lock or press fit is immaterial to the invention as the user of the syringe may rotate sufficiently to unscrew the needle as required or provide sufficient rotation of the syringe relative to the needle to demount the needle from the syringe, if a press fit. Thus, use of the needle remover 1 according to this embodiment is not limited to a single type of mounting of the needle 55 to the syringe 50. Further, as the gripping members 45 converge on the needle, the needle remover 1 is not limited to the size of the needle or hub as the gripping members will progressively converge until contact is made and so not requiring a specific size to which the needle remover is adapted. It follows therefore that the needle remover according to the present invention is adaptable to a much wider range of syringes than the devices of the prior art.

As shown in FIG. 7D on demounting of the needle 55 from the syringe 50, the syringe 50 may be removed 75. As the syringe is removed, the force on the sliding member 10 is also released, allowing the sliding member 10 to return to the original position. Because the vertical surface 12 of the enlarged portion does not immediately release the gripping members but permits a short “dwell time” as the sliding member moves upwards, the syringe may be removed with a short delay before the gripping members release the needle 55 allowing it to drop 80 into the sharps container.

1. An apparatus for removing a needle from a syringe comprising
a housing;
a sliding member slidingly engaged within said housing, said sliding member having a recess for receiving the needle mounted to the syringe;
at least two gripping members in communication with the sliding member such that on sliding the sliding member within the housing, the gripping members progressively converge, wherein;
the gripping members are positioned such that a point of convergence of the gripping members coincides with a portion on the needle to grip said needle, said gripping members arranged to prevent rotation of gripping said needle.

2. The apparatus according to claim 1, wherein the sliding member receives the needle whilst in a first position, said sliding member selectively slidable to a second position, such that the portion of the needle is coincident with the point of convergence of the gripping members, whilst the sliding member is in the second position.

3. The apparatus according to claim 2, further including resilient members to provide resistance against sliding of the sliding member from the first to the second position, such that on release of the sliding member, said sliding member is biased back to the first position.

4. The apparatus according to claim 1, wherein said sliding member includes inclined surfaces on an inside face of the sliding member, said inclined surfaces in contact with said gripping members, such that on movement of the sliding member from the first to the second position, the inclined surfaces bias the gripping members towards the point of convergence.

5. The apparatus according to claim 1, wherein the portion of the needle gripped by the gripping members includes the needle hub.

6. The apparatus according to claim 5, wherein the gripping members engage the needle hub through friction.

7. The apparatus according to claim 5, wherein the gripping members engage the needle hub through interference with flutes projecting from the needle hub.

8. The apparatus according to claim 1, wherein the syringe is rotatable within sliding member to permit demounting of needle.

9. The apparatus according to claim 1, wherein there are four radially spaced gripping members.

10. The apparatus according to claim 1, wherein said gripping members include a gripping portion of a viscoelastic material.

11. The apparatus according to claim 1, wherein said gripping members include a gripping portion of an olefin material.

12. The apparatus according to claim 1, wherein the gripping members are formed from the same material as the gripping portion.

13. The apparatus according to claim 11, wherein said material is polypropylene.

14. The apparatus according to claim 1, wherein said housing is adapted to engage a container.

15. The apparatus according to claim 14, wherein said engagement including connection to said container using any one or a combination of: an interference fit, a press fit, bolted connection or a screw connection.

16. The apparatus according to claim 1, wherein said housing is integrally moulded with a container.

17. The apparatus according to claim 14, wherein said container comprises a disposal container for the disposal of sharps.

18. The apparatus according to claim 1, wherein said housing includes ribs along a surface in contact with said sliding member, said ribs directed parallel to the path of the sliding member from the first to the second position, such that said ribs act to permit linear movement but prevent rotational movement of the sliding member.

19. A method of removing a needle from a syringe comprising the steps of:
inserting a needle mounted to a syringe into a recess of a sliding member, whilst said sliding member is in a first position, said sliding member slidingly engaged within a housing;
biasing said sliding member to slide within said housing;
said sliding member biasing at least two gripping members to progressively converge,
said gripping members positioned such that a point of convergence of the gripping members coincides with a portion on the needle to grip said needle;
gripping said needle with said gripping members so as to prevent rotation of said needle.

20. The method according to claim 19, further including the step of rotating the syringe whilst said needle is gripped so as to demount the needle from the syringe.

21. The method according to claim 19, further including the steps of:
releasing the sliding member;
biasing the sliding member to the first position using at least one biasing member;
releasing the gripping members and consequently releasing the needle from the gripping members.
